(19) United States
(12) Patent Application Publication
(10) Pub. No.: US 2019/0151761 A1
(43) Pub. Date: May 23, 2019

(54) ENTERTAINMENT USING CAPTURE DIGITAL DATA

(71) Applicant: Mark Krietzman, Palos Verdes Estates, CA (US)

(72) Inventor: Mark Krietzman, Palos Verdes Estates, CA (US)

(21) Appl. No.: 16/259,022

(22) Filed: Jan. 28, 2019

Related U.S. Application Data
(63) Continuation-in-part of application No. 14/846,402, filed on Sep. 4, 2015.
(60) Provisional application No. 62/702,899, filed on Jul. 24, 2018.
(60) Provisional application No. 62/047,060, filed on Sep. 8, 2014.
(60) Provisional application No. 62/184,361, filed on Jun. 25, 2015.

(51) Int. Cl. A63F 13/655; A63F 13/355; A63F 13/79; A63F 13/215; A63F 13/216

(52) U.S. Cl. CPC A63F 13/655; A63F 13/355; A63F 13/216; A63F 13/215; A63F 13/79

(57) ABSTRACT

A game played on a computing device using one or more data capture computing devices to blend the game and real world experience. Collection Machines may be in signal communication with each other and/or a network. The Collection Machines parse collected data by one or more criteria to decision if goal(s) are met. The correlation may be on a local computing device or a remote server or a combination of both. If a threshold level associated with the set goal is achieved; and, if goal is achieved the server transmits via the network to the application and the application at least one of unlocks game features and adds score points to the collection targets game.

### CROSS-REFERENCE TO RELATED APPLICATIONS

This application claims the benefit of U.S. Provisional Patent Application 62/702,899 filed Jul. 24, 2018 and entitled “GAME PLATFORM AND ENTERTAINMENT USING CAPTURED DIGITAL DATA”; and is a Continuation-in-part of U.S. patent application Ser. No. 14/846,402 filed Sep. 4, 2015 and entitled “HEALTH AND OTHER USE OF COLLECTION OF ARCHIVAL DIGITAL DATA”; which claims the benefit of U.S. Provisional Patent Application 62/047,060 filed on Sep. 8, 2014 and entitled “FAMILY ARCHIVE SYSTEM AND METHOD”, and Provisional Patent Application 62/184,361 filed Jun. 25, 2015 and entitled “SYSTEM AND METHOD TO MONITOR FAMILY MEMBERS AND COLLECT DIGTAL MEDIA AND RESPONSES”, the disclosures of which are incorporated by reference herein in their entirety.

### BACKGROUND OF THE INVENTION

### 1. Field of the Invention

The present disclosure relates generally to processing and categorizing captured digital media data for gaming, security and entertainment.

### 2. Background

Interacting with digital media device which capture, image, audio and movement in multiple spectrums is becoming commonplace. Children at a young age have learned to accept and thrive in an ecosystem in which digital captures of such data is ubiquitous.

Smart phones, computers, smart televisions, other computing devices and networks collect digital media such as audio, video, still photo, fingerprints, voices, biometrics and interact with a user at an increasing rate. Such devices can be in signal communication with a network.

### SUMMARY

People interact online with others, websites, accounts secure and insecure sites. Home Automated Servants (HAS) or home butlers/assistants are fast becoming ubiquitous. HAS are types of Collection Machines. HAS include but are not limited to Smart Speakers which include AMAZON™ ECHO™, GOOGLE HOME™ and APPLE HOMEPOD™ and other home butlers and security device robots, drones, may be autonomous or semi-autonomous and may have digital capture assets associated therewith. Virtual activities can intersect with real world activities Disclosed are methods and systems to connect real world activities with advancement in a virtual gaming environment. The gaming experience may be improved by getting involved in the real world.

Aspects of some exemplary implementations disclosed herein include a digital collection method and system include a computing device associated with an application (App) on a collection target's computing device is used to play a game; the game player sets at least one real world goal to be achieved via the App; one or more autonomous or semi-autonomous Collection Machines in signal communication with a network collect activity data from or about the game player; a sensor associated with the Collection Machine triggers the data collection when the game player is at a predetermined distance from the collection machine; the Collection Machine is in signal communication with a network; collected content data is both stored in the Collection Machine memory and processed to determine if a threshold level associated with the set goal is achieved; and, if goal is achieved the server transmits via the network to the application and the application at least one of unlocks game features and adds score points to the collection targets game.

Aspects of the system and method disclosed herein include but are not limited to a digital and real world game, the method of the game comprising a computing device associated with an application on a collection target's computing device is used to play a game; the game player sets at least one real world goal to be achieved via the app; one or more autonomous or semi-autonomous Collection Machines in signal communication with a network collect activity data from or about the game player; a sensor associated with the Collection Machine triggers the data collection when the game player is at a predetermined distance from the collection machine; the Collection Machine is in signal communication with a network; collected content data is both stored in the Collection Machine memory and processed to determine if a threshold level associated with the set goal is achieved; and, if goal is achieved the data may be transmitted via the network to the host for the application and the application at least one of unlocks game features and adds score points to the collection targets game. In some instances a sensor associated with the Collection Machine triggers the data collection. In some instances the Collection Machine utilizes one of image, voice, sound, movement, tracking device and heat as a criteria to initiate capture of data. In some instances the method further comprising processing the collected data according to at least one criteria. In some instances the collection targets activity is weighted by the server according to criteria to determine if the threshold is met.

Aspects of the system and method disclosed herein include but are not limited to preparing an entertainment graphic presentation, the method comprising: categorizing captured digital video or still photo content; using a filtering engine to at least one of categorize and filter the content; and, a reel of filtered and/or categorized content is generated. The categorizing and filtering may include processing metadata such as one or more of time, date, voice tags, word tags, voice recognition, face recognition, biometric key, keyword, icon, and geolocation. In some instances the categorization and filtering takes place on the smartphone. In some instances the categorization and filtering takes place on a remote server. In some instances the categorization and filtering takes place on a local computing device different than a smart phone such as a home automated servant.

Other devices, apparatus, systems, methods, features and advantages of the inventions disclosed herein will be or will become apparent to one with skill in the art upon examination of the following figures and detailed description. It is intended that all such additional systems, methods, features and advantages be included within this description, be within the scope of the inventions, and be protected by the accompanying claims.

The disclosure may be better understood by referring to the following figures. The components in the figures are not necessarily to scale, emphasis instead being placed upon illustrating the principles of the invention. In the figures, like reference numerals designate corresponding parts throughout the different views. All callouts in all figures are hereby incorporated by references as if fully set forth herein.

### DRAWINGS

FIG. 1 is an overview of a preselected delivery safe vault system and method;

FIG. 2 is an overview of another preselected delivery safe vault system and method;

FIG. 3 is an overview of another preselected delivery safe vault system and method utilizing sub vaults;

FIG. 4 is a system overview;

FIG. 5 is a system overview;

FIGS. 6A and 6B show an overview of a system to collect real world activity data and an example of aspects of the use thereof;

FIGS. 7A and 7B show aspects of an access and deliver process;

FIGS. 8A-8C show aspects of reminder to capture systems;

FIG. 9 shows aspects of a CSM for filtering capture digital data into preselected forms for delivery;

FIG. 10 is a responsive advertising and marketing module which uses collected digital data to market and advertise to individuals or some subpopulations; and,

FIG. 11 shows aspects of a processing module for targeted advertising and marketing.

### FURTHER DESCRIPTION

It is appreciated by those skilled in the art that some of the circuits, components, modules, and/or devices of the system disclosed in the present application are described as being in signal communication with each other, where signal communication refers to any type of communication and/or connection between the circuits, components, modules, and/or devices that allows a circuit, component, module, and/or device to pass and/or receive signals and/or information from another circuit, component, module, and/or device. The communication and/or connection may be along any signal path between the circuits, components, modules, and/or devices that allows signals and/or information to pass from one circuit, component, module, and/or device to another and includes wireless or wired signal paths. The signal paths may be physical such as, for example, conductive wires, electromagnetic wave guides, attached and/or electromagnetic or mechanically coupled terminals, semi-conductive or dielectric materials or devices, or other similar physical connections or couplings. Additionally, signal paths may be non-physical such as free-space (in the case of electromagnetic propagation) or information paths through digital components where communication information is passed from one circuit, component, module, and/or device to another in varying analog and/or digital formats without passing through a direct electromagnetic connection. These information paths may also include analog-to-digital conversions (“ADC”), digital-to-analog (“DAC”) conversions, data transformations such as, for example, fast Fourier transforms (“FFTs”), time-to-frequency conversations, frequency-to-time conversions, database mapping, signal processing steps, coding, modulations, demodulations, etc.

Computing devices may be computers, laptops, smart phones, tablets and devices with processors and memory in them such as drones, robots, and other device that can capture at least one audio, video, photo, biometric data, health, voice, image and gps (location) data. Such devices may be a child's stuffed animal with embedded computer, a home robot, a smart phone or a child's learning device with the capability to record the above type of information related to the user and then upload same via a wired or wireless communication to the archive.

The data captured in some instances discussed is converted to, or saved as, digital data for analysis, archiving and transmission. A vault or family archive includes a first communication device (i.e. HAS, smart phone or other computing device), a database, a server, a release/delivery decisioning process, a second communication device and one or more controller. The controller may be software operating within the sever. The communication devices, server, database are in signal communication with each other.

Overview: In a basic form the vault allows a person (the user) to save a digital image, or message for a loved one or associate (hereinafter also known as a “Vaultee”) and to secure said message for delivery if the user (hereinafter also known as the “Vaultor”) dies or is incapacitated. Content includes but is not limited to emails, documents, video, audio, passwords, account records, jpegs, mpegs, and records. A secure interface which may be an application (software) on the user's computing device allows a user to tag, and store the content or to permission third party to deposit information. In a more complex variation the archive is for a family and reminders, alerts and devices interrupt are used to help train the family of Vaultor i.e. children (or the Vaultor) to archive or journal one's life in according to a schedule which may be fixed or dynamic.

In addition to vault content collected, stored and created for and by user, the user may use the vault as a legacy archive to aggregate and segregate passwords and credentials for login in to web based services, programs, and sites. When a user (Vaultor) adds an application to his/her computing device the Vaultor can specify which passwords and other login criteria (user name, IP address, MAC address, nickname, security questions) for what websites and service (banks, social networks etc.) to place in a vault or a sub vault for safe keeping. Such login in criteria for legacy use and to manage digital assets during a user's incapacity or after a Vaultor's death of the user whereby heirs and designees (Vaultees) may, upon decision of incapacity, death or other user defined data distribution condition (DDC) whereby he/she gains access to the some or all of the digital content of the safe vault(s). The Vaultor's computer account login credentials may be saved in segregated vaults wherein separate access may be provided to separate designated individuals on one or more DDCs. The login credentials may be passed to an executor or proxy whom has administrative level authority to deliver content and/or vault or sub vault access to person(s) pursuant to a DDC.

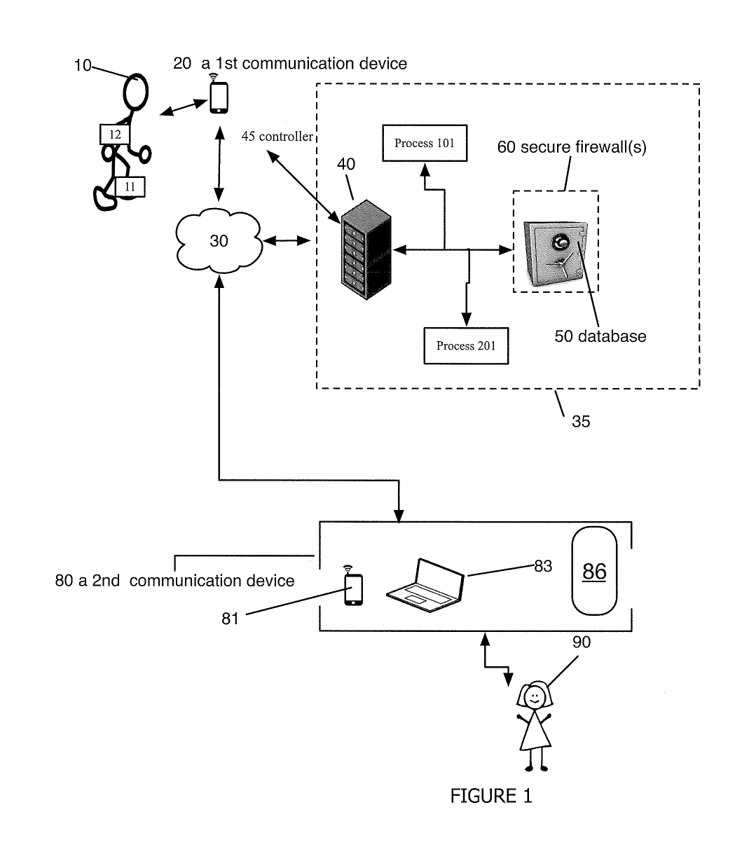

In operation, FIG. 1, discloses some aspects of a system and method to capture or store and deliver or release to specified person or persons last message, or other content from a secured vault from an originator/user (Vaultor) 10.

A Vaultor 10 utilizing a smart phone 20 which is a first communications device in signal communications via a network 30 with a website 35. The smart phone 20 may also have the safe vault application installed. The originator interacts with a safe vault application or the vault website to provide digital content (which may be created via a text or, video, or jpeg or audio function of the smart phone) to the safe vault to be held for delivery if a catastrophic event occurs (i.e. death, disappearance, in capacitance, capture and the like). Rule and/or decision engines provided by one or more of servers 40 and controllers 45 cycle through a process 101 to verify and/or authenticate the originator to vault content for a preselected release or delivery. Rules include verifying if an originator is incarcerated, incapacitated or dead.

In some exemplars such verification is via a trusted friend or designated person. In some exemplars verification is via a web crawler which searches the web for records of the originators status and provides that search result to an administrator for verification. In some exemplars verification is via the loss of contact with an originator for more than a set period of time.

In some exemplars loss of contact refers to the situation wherein the originators biometric are not found on a record accessible through a network. In some exemplars loss of contact refers to the situation wherein the a record of an originators RFID tag, or other implantable device (11) which sends a health or life signal is not found on an record accessible through a network.

In some exemplars loss of contact refers to the situation wherein the originators life signs from a wearable device (12) has not reported a life sign for a predetermined period of time. The interface for setting up the vault verifies and allows the originator to connect the records of life signs via a wearable device or implantable device to the servers 40 whereby the records are verified.

Controllers in this instance are software which the originator (Vaultor) interacts with to establish authenticity of the Vaultor and to guard and control the release of vault contents to an intended recipient (Vaultee) in the event of a data distribution condition (DDC). The verification may include authentication of the originator credentials, biometrics or other security procedures. Biometrics may include pheromones, voice, face, image, fingerprint ID, ID, breath, DNA, breath and other measures of an individual via their physical or chemical characteristics. In some instances multiple party verification may be specified. The digital content is saved in memory in a database 50 and the database can be secured by one or more of firewalls and encryption 60. In the event of a deliver event (catastrophic event) also called DDC the controller 45 utilizing decision and/or rule engines determines via a process 201 if content is to be delivered. The decisioning process may include collecting data via a robot or web crawler, a news filter, on such subjects as the originators social security number, tax rolls, obituaries, death certificates, news. Records searched may be public or privates. Other sources may be one or more of employers, insurance companies, banks, and hospitals. As previously noted, other sources may include be record of health or life sign of an originator one of cameras, scanners, monitors and the like. Using health information probability of incapacity may be ascertained.

If and when a decision to allow a non-originator to have access to stored content or to apply for delivery or release of the stored content it is done through a computing device which may also be a second communications device 80. The communications device 80 allow a recipient (Vaultee) 90 via a smart phone 81, other computing device 83 or HAS 86 to communicate with servers. The process of delivery may also require authentication of the vaultee. That is, merely delivering to a vaultee's smart phone may be inadequate security in some instances. A smart phone or other computing device may be shred or stolen. To maintain higher security the process 201 may include authentication of the Vaultee credential, via biometrics or other known security procedures. Biometrics may include voice, face, image, fingerprint ID, facial ID, breath, DNA, breath and other measures of an individual via their physical or chemical characteristics. A record of the Vaultee's biometrics may be provided by the Vaultor to the servers.

Alternatively a registered member of the safe vault network who is properly identified as a unique individual can have their authentication of the credentials, including biometrics and chemical or other security procedures in an authenticated file.

Alternatively, the safe vault may create one or more of a chemical, security, authentication and biometric record for each Vaultor and be able to leverage that database to authenticate a person who is an originator for his/her own vaults but is a recipient to others.

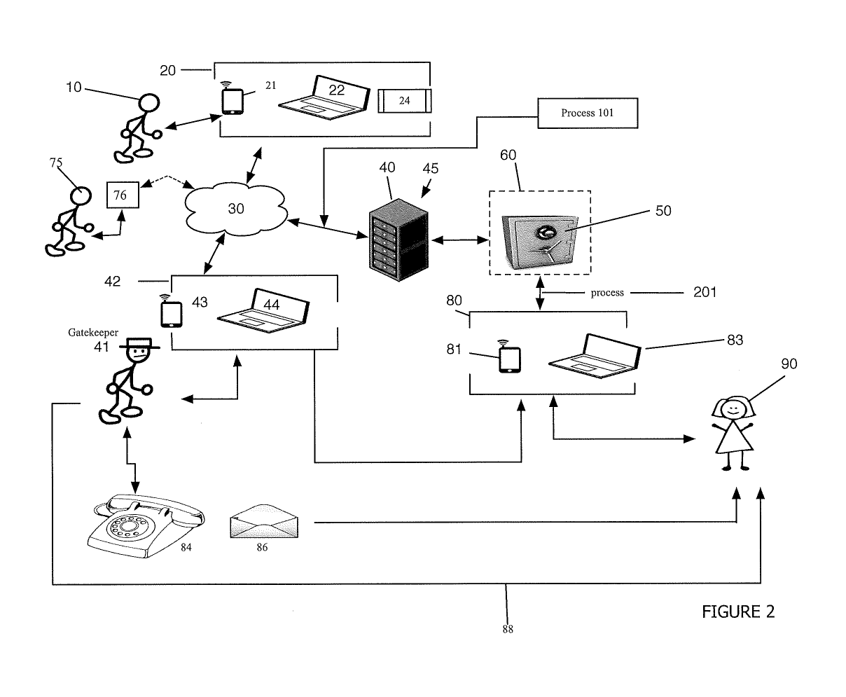

FIG. 2 provides another overview of aspects of a system and method to preordain delivery of last messages and/or content of an originator 10 utilizing a first communication device 20 which may be a smart phone 21 &22, a computer 23 or other capture device 24 capable of saving digital content or of access of a safe vault or safe vault website. Other devices may include smart TVs, car navigation systems, HAS robot and drones and the like. Access may be via an application on the communication device (which in this instance is also a computing device) or via Internet access to a website.

The first communications device is in signal communications with a server via a private, or public network 30/31. A network may include a mix of wired and wireless technologies. Network devices communicate through wired or wireless transmission media. Signal communications include includes wifi, nfc, cellular and wired. The first communication device interacts with a safe vault application or the vault website to provide digital content (which may be created via a text or, video, or jpeg or audio function of the smart phone) to the safe vault server(s) 40 to be held for delivery upon an event. A catastrophic event such as (i.e. death, disappearance, and incapacitance), other events include marriage, graduation, a birthday, a grandchild's birth, a date, holiday, the death of another, capture (military and the like) etc.) such events may be referred to as a Data Distribution Condition (DDC). In some instances content may include manual or automatic scrapping the vaultor's FACEBOOK™, LINKEDIN™, TWITTER™, SNAPCHAT™ or other social or professional network and includes securing (in a usable form), passwords and user names for such sites, browsing history, use history, and passwords, user names and the like for online accounts, and also for financial accounts.

In some instances content may include archived emails, documents, pdfs, jpegs, photo library's, cloud, DROPBOX™ and other places Vaultor has credential or an account that may have Vaultor's digital assets.

In some instances the originator via the smart device 20 may provide one time, limited or unlimited credentials or a key to allow a third party 75 via the third parties computing device 76 whereby an authenticated third party 75 is provided the credentials or a key to add content to the vault 40. The servers 40 must authenticate such a third party before content can be allowed to be added. As previously noted, rule and/or decision engines provided by one or more of the servers 40 and controllers 45 cycle through a process 101 to allow the originator (vaultor) to vault content for a preselected release or delivery in the event of a DDC. The allowance includes authentication of the originator credential, may include biometrics or other security procedures. The content is saved in memory in a database 50 and the database is secured by one or more of firewalls and encryption 60. In some instances a gatekeeper 41 may be appointed by at least one of the originator 10, server 40 and the controller 45. The gatekeeper may be an individual or an entity or a group of individuals. The first communication device 20 is in signal communication with the server 40 and the gate keeper's third communication device 42 (which may include phones 43, laptops 44 and tablets or wearable device not shown). In some the first communication device is communicating with the gatekeepers third communication device to device and in other instances the server 40 acts as an intermediary. In those instances when the gatekeeper 41 has previously agreed to act as a gatekeeper his/her third communication device may be enabled to accept the role of gatekeeper automatically and without the gatekeepers actual knowledge of who the originator is, or if known when the originator made the request. In those instances when the gatekeeper 41 is contacted he/she will have a user interface whereby acceptance of appointment of gate keeper obligations is agreed to.

Although a gatekeeper 41 in some instances will not have access to the materials in the safe vault. The gatekeeper has at least one role to provide the recipients(s) a digital key or credentials to the safe vault and to be at least a part of the decisioning process of whether content should be delivered to a particular recipient. In some instance even the gatekeeper must by authenticated before he/she may be provided a key or credentials for the recipient(s) a registered member of the safe vault network who is properly identified as a unique individual can have their authentication of the credentials, including biometrics and chemical or other security procedures in an authenticated file. Part of the process of being a specific gate keeper selected by originator or of being an ad hoc gate keeper is that the gate keeper has the option of providing an authentication library of data such as security questions, biometrics and chemical to assure that a gatekeeper can be verified prior to delivering even the key or credentials for the recipients to the gatekeeper(s).

In the event of a Data Distribution Condition (DDC) 500 at least one of the controller 45 via a process 201 and the gatekeeper 41 determine if a digital key or credentials to access content, is to be delivered to a recipient. The decisioning process may be a stepwise process wherein the controller 45 must first communicate with the third communication device before the gatekeeper 41 is provided a key which may be provide from the gatekeeper's to the recipient. Communication to recipient (Vaultee) may by third communication device to second communication device, or it may be via telephone 84, or it may be via hard mail, or by personal contact 88. If and when a delivery or release of the content to a Vaultee 90 is decisioned to occur then via signal communications to a second communications device 80 such as smart phone 81 or other computing device 83 a digital key to retrieve the content—when and if the Vaultee is properly authenticated, is delivered.

In some instances the decisioning process may be a step wise process wherein the controller 45 must first communicate with the third communication device before the gatekeeper is given authority to one of instruct the server 40 to provide a digital key to the safe vault of the originator or provide a digital key (which can only be used by recipient) directly from the third communication device to the second communication device—all in signal communication with each other and having memory, processors, hardware and software.

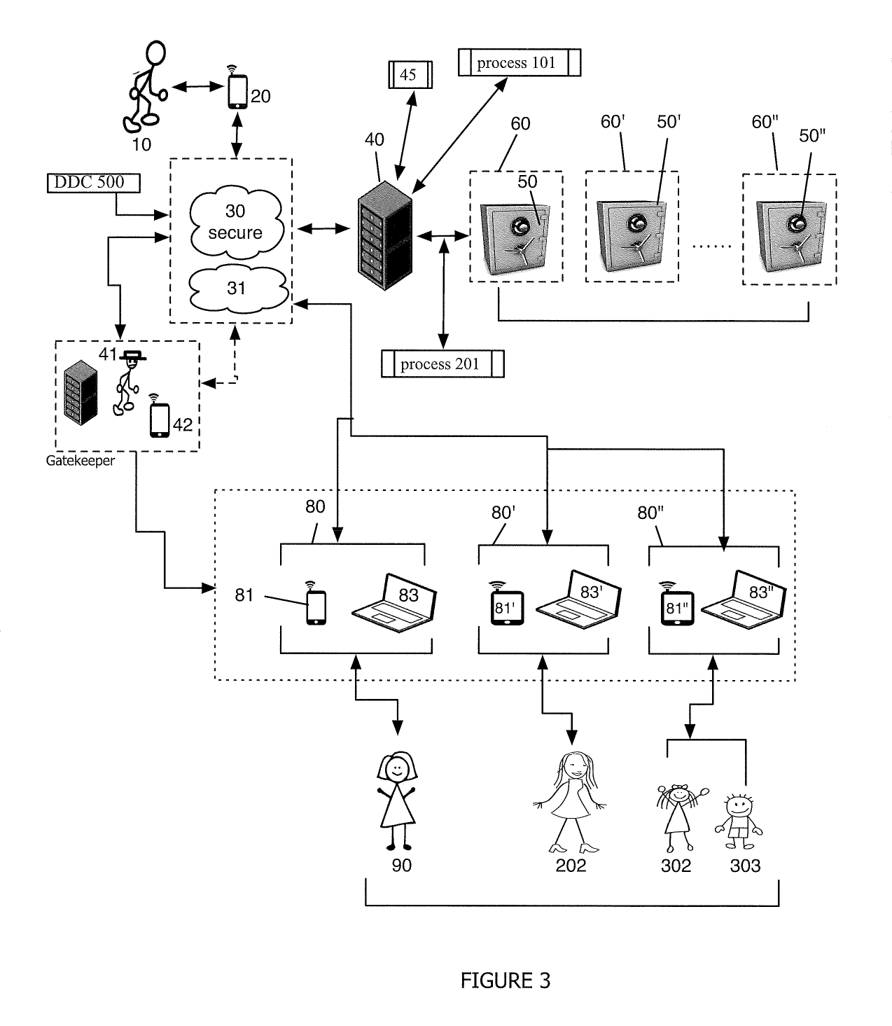

FIG. 3 provides another overview of aspects of a system and method to preordain delivery of last messages and/or content of an originator 10 utilizing a first communication device 20 capable of access the safe vault website via signal communications through a network 30/31. The first communications device is in signal communications with a website via a private, or public network 30/31 and it interacts with an application or a website to provide digital content (which may be created via a text or, video, or jpeg or audio function of the smart phone) to the server(s) 40 to be held for delivery if a DDC occurs. Rule and/or decision engines provided by one or more of the servers 40 and having controllers cycle through a process 201 to allow the originator to vault content for a preselected release or delivery in the event of a catastrophic event. The allowance includes authentication of the originator credential, may include biometrics or other security procedures. The content data is saved in memory in one or more databases 50-50″ and the database is secured by one or more of firewalls and encryption 60-60″ the array of vaults may be in the same database or different databases. The access privileges and permissions for each vault 50-50″ may be different. The recipients such as spouse or significant other 90, girlfriend/boyfriend 202, children 302/303 may receive access key(s) for the same or for different safe vaults.

In some instances, a gate keeper 41 may be appointed by at least one of the originator 10, server 40 and the controller 45. The gatekeeper may be an individual or an entity or a group of individuals. The first communication device 20 is in signal communication with the server 40. In some instances the originator's first communications device 20 is in communication with the gatekeepers third communications device 42. In some the first communication device is communicating with the server 40 and the server in turn is an intermediary which communicates via signal communications to the third communications device. In those instances when the gatekeeper 41 has previously agreed to act as a gatekeeper his/her third communication device may be enabled to accept the role of gatekeeper automatically and without the gatekeepers actual knowledge of who the originator is, or if known when the originator made the request. In those instances when the gatekeeper 41 is contacted he/she will have a user interface whereby acceptance of appointment of gatekeeper obligations is agreed to.

The gatekeeper does not have access to the materials in the safe vault. The gatekeeper has at least one role to provide the recipient(s) a key to the safe vault and to be at least a part of the decisioning whether the key should be delivered to a particular recipient.

In the event of a DDC at least one of the controller 45 via a process 201 and the gatekeeper determine if a digital key (credential) to allow an intended recipient (IR) to try and retrieve content is to be delivered. The decisioning process may be a step wise process wherein the controller 45 must first communicate with the third communication device before the gatekeeper is provided a key which may be provide from the gatekeeper's to the recipient.

In some instances the decisioning process may be a stepwise process wherein the controller 45 must first communicate with the third communication device before the gatekeeper is given authority to one of instruct the server 40 to provide a digital key to the secured archive (i.e.safevault) of the originator or provide a digital key (which can only be used by recipient) directly from the third communication device to the second communication device—all in signal communication with each other and having memory, processors, hardware and software.

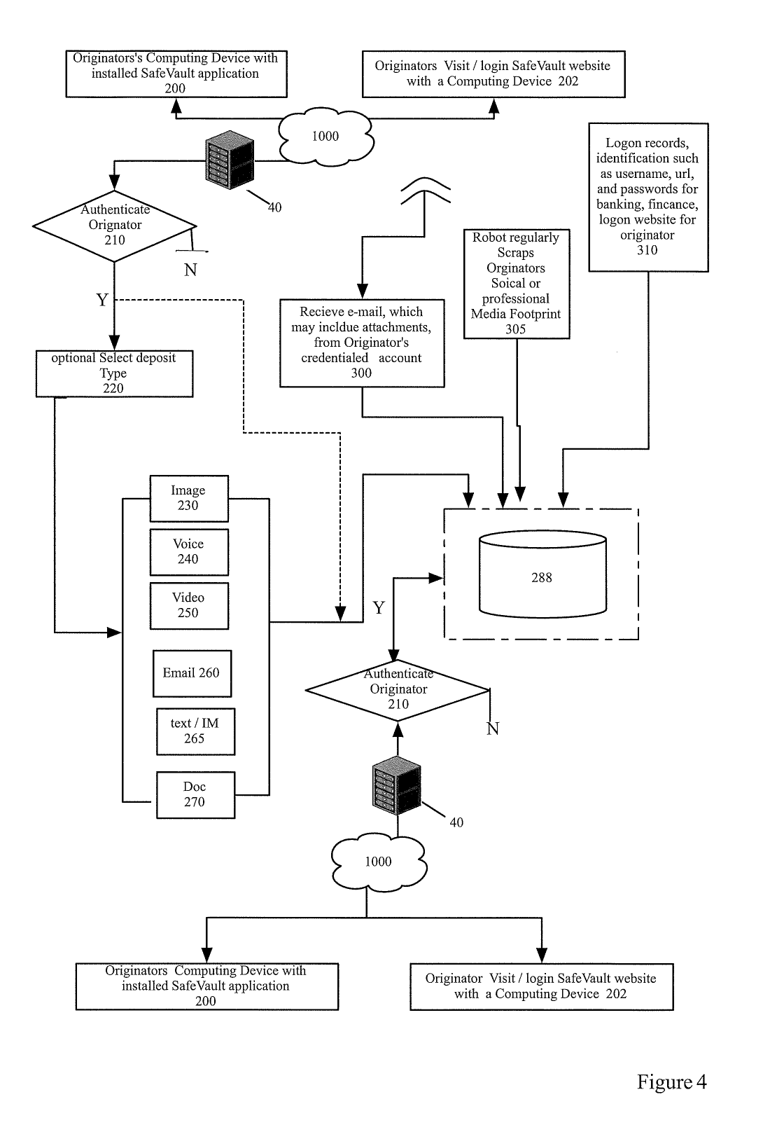

FIG. 4 shows aspects of the method and process of an originator (Vaultor) interacting with a safe vault. The Vaultor using one of a computing device with a safevault application installed thereon 200 and a safevault website 202 to login to-a network 1000 which communicates with a server 40. The server 40 authenticates the originator 210 which may include but is not limited to passwords, security questions, device identification (hardware), device location (gps), the IP address, and biometrics. If authenticated then the Vaultor may optionally select a data type for archive 220 categorize may be personalized some can include image (jpeg, pdfs, tiff and the like) 230 voice 240, video 250, email 260, IM (instant message)/text 265 and docs 270 (such as word file, spreadsheet, text, flow diagrams other manipulatable non-photo files). That data is stored in a database 288 structure for the safevault.

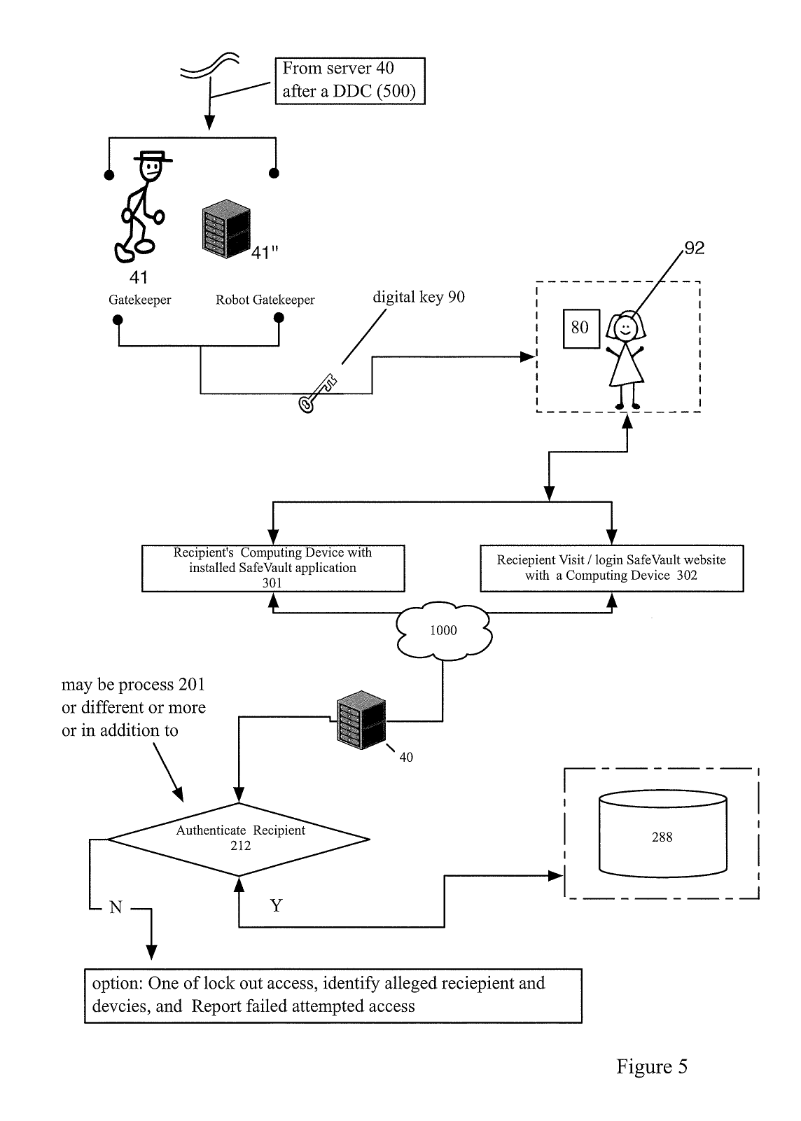

FIG. 5 illustrates aspects of a method and system of a recipient post DDC 500 interacting to try and gain access to safevault content. The server 40 contacts at least one of a gatekeeper 40 and a robot gatekeeper 41 via signal communications to a computing device wherein the gatekeeper(s) provide a digital key 90 to an intended recipient 92. The recipient using a computing device 80 is either communicating with the server via an application 301 or via a website 302. The server then attempts to authenticate the recipient 212. Rule and decision engines in the server go through at least a process 201 to verify or authenticate the alleged recipient. The process may include but is not limited to passwords, security questions, device identification (hardware), IP address, device location (gps), biometrics and confirmation of digital key 90. If authenticated 212 the recipient is allowed the appropriate level of access to the safevault database 288. If the authentication fails the servers may optionally one or more of lock all access to the safevault database 288 and report failed attempted access. The report may include placing the alleged recipient, the computing device, the IP address, the MAC address, machine ID, location, or other identifier on a black list which is one of denied access to the specific safevaults until the threat of a data breach is neutralized and denied access to any safevaults.

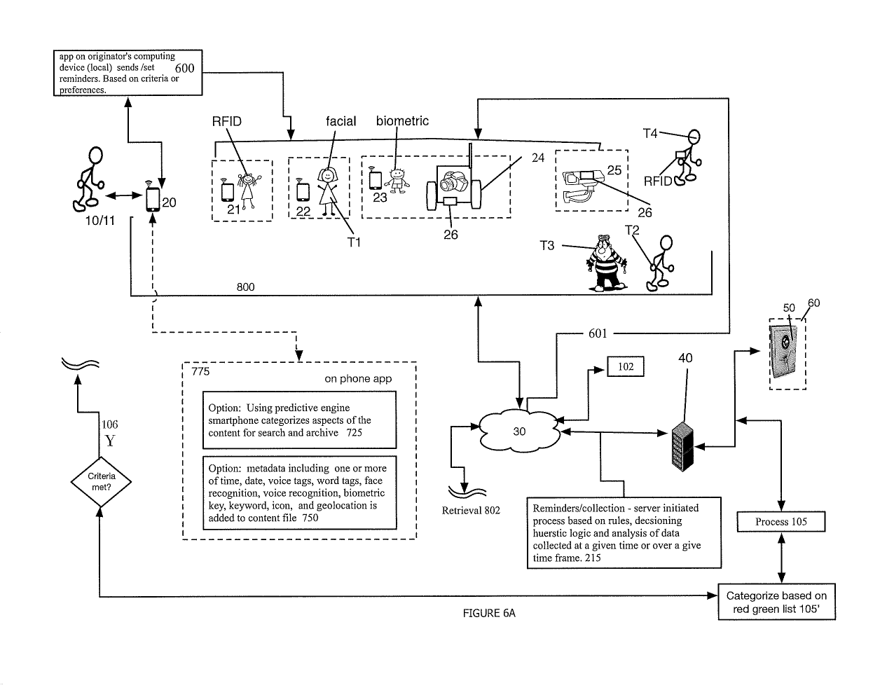

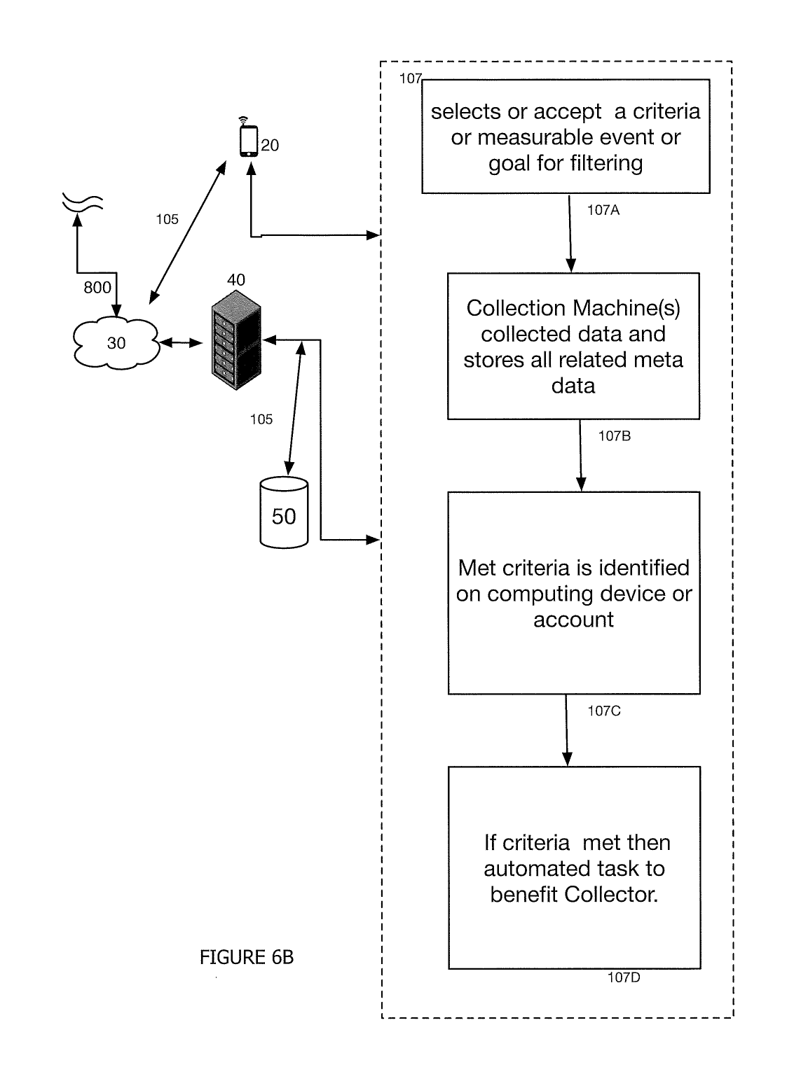

FIGS. 6A and 6B illustrates aspects of a local or family data collection. There are also disclosed two processes which may be combined to urge, cajole or otherwise help a smartphone user, sibling, parent caregiver and/or collector to acquire data about or from a child or other Collection-Target. Those of ordinary skill in the art will recognize that a child system and method may also be utilized for a collection-target including but not limited to the elderly, disabled, infirm or mentally incapacitated. Collector means someone collecting digital data on/about the Collection-Target (which may be children, siblings, spouses, parents or friends and pets and places, non-human living things, or non-living objects). Digital data includes but is not limited to audio, location, date, time, sensory data, video, biometric, voice, medical, physiological statistics such a as breathing, blood sugar, oxygen saturation, cognitive data about actions such as speed, response time, interaction with set tasks or tests, physical test, and chemical. Parents or collector use this system to collect or acquire digital media and digital data about the Collection-Target. Collection may be distributed among many with each collection device (and person or robot) associated therewith acting as a collection node for that Collection-Target.

In some instances a parent 10 or collector 11 utilizing a GUI communicating with an application has set the criteria on a smart phone (or other computing device) 20 to send reminder 600 to the computing devices 21-25 associated with Collection-Target (also referred to as POO) to capture digital and/or store in a database, which may include data, metadata and/or digital media, including but not limited to image, jpeg, mpeg, video, voice, sound, audio and biometric from or about the Collection-Target. The smartphone 20, a computing device, may capture digital content data (i.e. be a Collection Machine). A fixed digital video capture device 25 is for purposes of this application is a computing device and a Collection Machine. A computing device and/or server 40 processes 107 data collected by Collection Machines. The processing may involve sorting, filtering and categorizing content by criteria which includes but is not limited to biomarkers, biometrics, voice, image, location, date, time and RFID associated with Collection Target.

In a game environment the Collection-Target may choose to interact with an application on his/her computing device or an account on an online game and set goals (107A) to achieve in the real world. A collection target who is involved in such a game is also known as a game player. The gaming app or gaming website may be referred to as the host and said host may suggest goals such as fitness goals and health goals. The App may be permissioned to receive updates on the achievement of a goal. Achievement generally means a measured action that exceeds a threshold. Levels of achievements may also be set and the App collects all related data and meta data (107B). The collected data can be parsed, filtered, and categorized to determine if criteria is met 107(C). If criteria is met or if in the gaming environment a goal (criteria) is met, a server that is remote from the computing device communicates the completion of criteria to a collector and/or the collection target's computing device (107D), in a gaming model that may include unlock a portion of the game on the app or add numerical value to the collection targets score.

In a non-game environment a collector or Collection-Target may choose to interact with an application on their computing device to select, set or accept a computing device suggested criteria. A non-exclusive list of criteria include but are not limited to filter by date, event, location, digital image, subject person(s), and/or time (107A). Collected data is saved in a database (107B). The collected data is at least one of parsed, filtered, and categorized to determine if criteria is met 107(C). If criteria is met the computing device or a server which may be remote from the computing device communicates the completion of criteria to the collector and/or the Collection-Target's computing device and an automated processing may occur such as filtering an image or sound database (107D).

Autonomous or semi-autonomous digital data collection device affixed to or provided by a robot, home automated servants (HAS), fixed digital recording device, moving digital recording device, robot and/or drone generally referred to as “Collection Machines” with one or more video, audio, sensory capture devices collect data including but not limited to image, location, sound and/or communicate with a Collection-Target. A computing device or application. May set the criteria for collection with at least one Collection Machine.

A parent 10 or collector 11 that set collection criteria for the Collection Machines. The child or person of interest (Collection-Target) may be identified via any known method. Methods to identify a subject child or person include but are not limited to RFID tag, biometric, face, chemical, scent, image, voice, geolocation, movement, sound, heat or other ID and/or tracking device which may include RFID or GPS implanted or attached thereon to provide target acquisition or identification for robotic or other autonomous or semi-autonomous data capture by way of a Collection Machine. A non-limiting example of such data collection or capture may be accomplished by fixed cameras such as home security or home automated servant (HAS). For example a child on the grounds of a property that is part of the family network is permission to, or otherwise does, capture the location or identification tag associated with the child.

These tracking and capture functions may also be applied to an invited or uninvited visitor at a site/pet or other automated autonomous or semi-autonomous device or sentient being in movement. The data collected is then sent via signal communications to a network 30, a server 40 or, smartphone 20 or other computing device which utilizes a process of decisioning to authenticate 105 the source of the data being collected and if authenticated the data is directed to one or more libraries and/or to one or more vaults or sub vault. The data may also be processed to compare with lists (105′) to determine if an alert (106) should be sent based on one of dynamically changing criteria and pre-set criteria. During upload to the vault the server may use facial and voice recognition to add meta data to the digital data to mark, tag, or otherwise categorize it with keywords or other retrieval information. Other data/metadata may include source or capture (the computing device), time, identification means used (i.e. gps, RFID, biometric, scent etc.) and date.

Each computing device may also have its own authentication procedure or digital key entry to the vault which directs the upload to the correct library, vault or sub vault. Server 40 may also provide notification to the computing device of a parent or collector 10/11 of a new data capture and/or upload.

Those of ordinary skill in the art will recognize that within the scope of this disclosure is applying the collection methods herein to not a child but in some instances any Collection-Target and in some instance the group of POOs and in some instances a focus of collection (FOC) person such as a noteworthy person T2 or a person determined at least in part by one of a user selected criteria and Collection Machine criteria which is applied pre or post data collection. Voice and facial recognition can be used to identify the noteworthy person. In some instance the noteworthy person is a without permission to be at or near the Collection Machine.

The Collection Machines may be in signal communication with a network which may include remote servers having databases, which may include subscription or third party databases 108 access based on authentication 40′ and via a network 30 in signal communication with one or more of the Collection Machine and the User's computing device. Said database containing identification information on noteworthy persons placed in collections based on criteria. Criteria may be developed from data from one or more Collection Machines within a network. Criteria may include criminal record, legal restraining orders, or merely establish that said noteworthy person is listed in said database 108 versus an unknown person. List may be divided into subgroups such as white list—black list or green list—red list indicating whether the captured data concerning the noteworthy individual should be used to alert the user, a third party service or authorities of a safety risk. In some instances the database 108 may be accessible by service providers and the like to remove, update and provide identification data on employees such as delivery persons, police, utility workers, domestic workers, caregivers and the like. or Such databases are used, at least in part, as collection criteria. In other instances collection criteria may be from one of a remote and a local database of noteworthy persons images or other biometric, other criteria maybe specified RFID tag, smartphone ID, wearable device ID, chemical tag or DNA marker. A person with a specific biometric, voice, face, stranger T3, an invited guest or uninvited guest or delivery person T4 and the like. Sensors 26 in addition to the image an audio collection elements of the Collection Machines would be used for collecting such information.

In some instances a server 40 is allowed to robotically, based on criteria 215, send reminder 601 to the computing devices 21-24 of, or associated with, Collection-Target or other Collector or authorities 103 to collect digital data. In some instances a sensor 26 associated with or on the Collection Machine to trigger a data collection. Said sensor(s) may be set to a key word, an activity, movement, interaction between Collection-Targets, sound or command. Other sensors may be triggered by time of day, RFID, machine ID of devices associated with Collection-Target(s) or biometrics associated with Collection-Target(s).

In some instances Collection Machines may utilize video, audio and sensory capture modules and hardware including microphones, touch screens, headphones, speakers or screens (monitor) to communicate with the Collection-Target. The Collection-Target may have RFID or other ID and/or tracking devices (discussed above) or utilize other tracking means (chemical, biometric, movement, heat, image scent, voice and the like) to provide targeting for Collection Machine autonomous or semi-autonomous data capture. Such capture may include Collection Machines such as fixed cameras and HAS. Child location verification may be achieved by tracking on the grounds of a property that is part of a family network permission, or otherwise enabled, to, capture the location or identification tag associated with the child. Although not shown, the tracking and capture functions apply equally to a visitor at a site, a robot, drone, pet or other autonomous device or sentient being in movement at or near the Collection-Target. The data collected is then sent via signal communications to a network 30 to a server 40 which utilizes a process of decisioning to authenticate the source of the digital data being collected and if authenticated the data is added to the proper vault or sub-vault. In some instances the data being processed may trigger an alarm 102 condition to contact the Collection-Target and/or to contact a designated person, user 10/11 parent or guardian or authorities. Alarms may be based upon rules to decision if a Collection-Target is in need of help or may be in a dangerous situation.

During upload to the vault the server may use facial and voice recognition to add meta data to the digital file to categorize the subject matter. Other meta data may include source or capture (the computing device), time and date and GPS. Other filtering or addition of useful manipulation of the uploaded that may be utilized during upload includes selecting a codec for video digital media, encrypting the upload, creating thumbnail of lower resolution and smaller size. Each computing device may also have its own digital key entry to the vault (or family vault) which directs the upload to the correct vault or sub vault. Server 40 may also provide notification to the computing device of a parent or other registered person when a data upload/collection is made.

Those of ordinary skill in the art will recognize that within the scope of this disclosure is notification of persons or computers other than a parent or guardian in the case of data collection on not a child but on a stranger, guest or person of interest.

In some instances a server 40 is allowed to robotically, based on criteria, send reminder 601 to the computing device 20 of the parent or collector 10/11. asking suggestions or pushing them to meet a collection criteria which the server has decisioned has not been met or should be adjusted. In other instances the reminder may be instructions sent to a drone 24. The collection device which contain the digital data content include but are not limited to the devices 20-25.

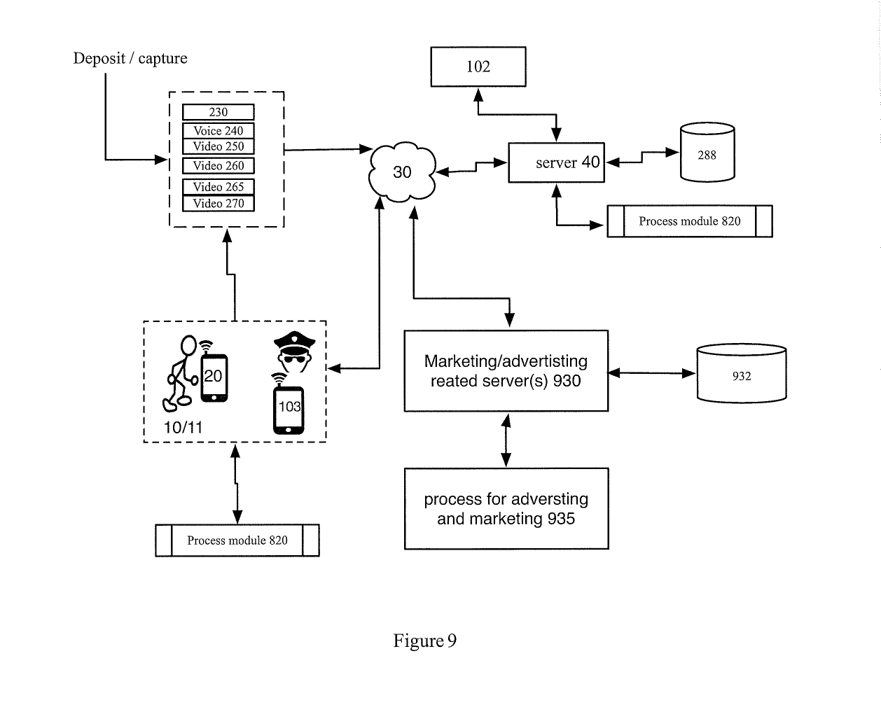

This may result in the drone, parent or collector collecting the scheduled data in those instances when the parent or collector is also a collection node for acquiring collection material. The drone 24, parent 10 or collector 11 may choose to authorize the additional collection schedule and allow the server to robotically collect, or the parent 10 or a collector 11 may adjust his/her computing device to send reminders on a modified schedule. Reminder(s) 600/601 are then sent to computing devices or HAS 86 associated with the Collection-Target—The data collected is then sent via signal communications to a network 30 to a server 40 which utilizes a process of decisioning to authenticate the source of the digital data being collected and if authenticated the data is added to the proper safevault or sub-vault. During upload to the vault the server may use facial and voice recognition to add meta data to the digital file to categorize the subject matter. Other meta data may include source or capture (the computing device), time and date and GPS. Each computing device may also have its own digital key entry to the vault, safevault (or family vault) which directs the upload to the correct vault or sub vault. Servers may also provide notification to the computing device of a person with access privileges, when a data upload/collection is made. Retrieval of the data upload 802 may be via accessed as previously discussed or may be via push to or pull summary of predefined criteria (See FIG. 9).

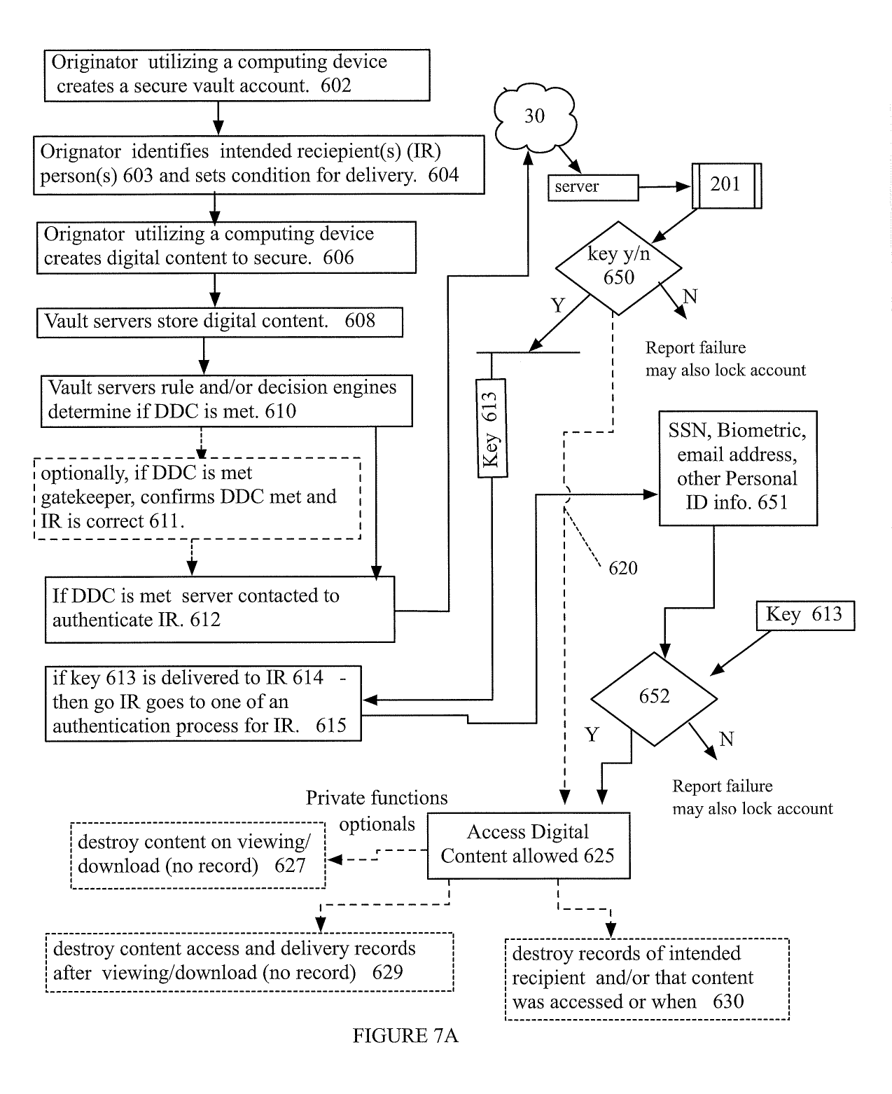

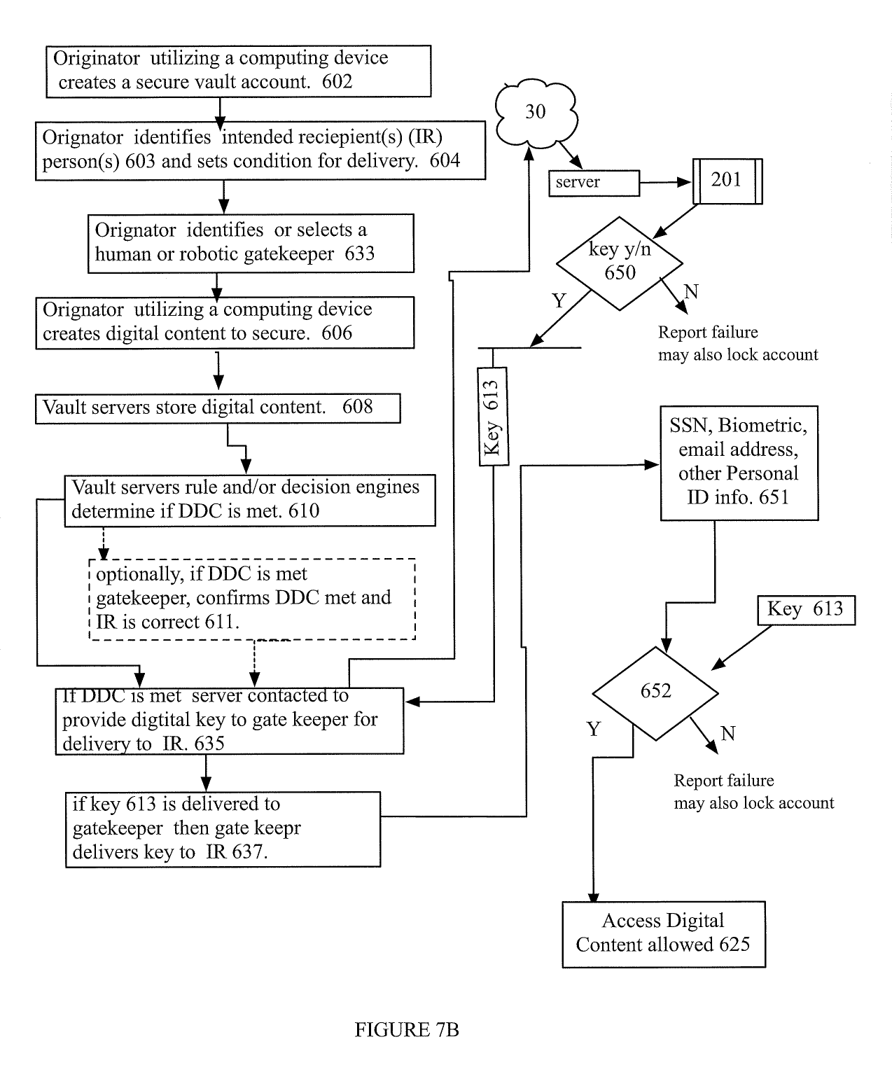

FIG. 7A illustrates some aspects of a workflow for an originator using a secure vault and an intended recipient being provided tools to access digital records. In some instance the intended recipient goes through multiple levels of security screening prior to authentication and being granted access. An originator via a computing device creates a secure vault account 602. An intended recipient, in this exemplary is if said intended recipient is otherwise authenticated.

Once a vault account is created (or during the set-up process) the originator is prompted to identify intended recipient(s) 603. The originator is also prompted to establish DDC (digital delivery conditions) 604. Prompts may include suggestion regarding social, economic, health, legal and other events which can trigger a DDC. Prompts may also include dates, time or gaps of times that may trigger a DDC. In those instances wherein the originator has linked biometric devices either remote or implanted in user, the data from such devices may be triggers for a DDC, in other instances gps from an implanted tracking device or from a computing device or senor not-implanted but associated with originator may be used.

The originator then utilizes a computing device to create or send data 606. The originator is able to store digital data content 608 in the vault. A very simple example is a first responder storing an audio or video or audio/video message for a loved one or other person in the event that he/she is killed or incapacitated that day. A more complex example is an originator adding voice notes, movie files and specific emails, documents, passwords, scraped social or professional network user pages etc. as records to be given to the intended recipient(s).

Once the originator account is activated the servers utilizing rule and/or decision engines determine if DDC or DDCs are met 610.

If DDC is met (optionally) a gatekeeper determines at least one of if the DDC is met and is the intended recipient(s) correct 611.

If DDC is considered met by one of server and gatekeeper+server then intended recipient contacts server via computing device and server utilizing a process determines whether or not the key should be delivered 650. If it is not delivered the server optionally contacts the server and/or gatekeeper and reports failure. Server may also lock out account until potential unverified intended recipient/error/fraud is evaluated.

In some instances if intended recipient is authenticated then key 613 delivered to intended recipient 614 then the intended recipient goes through a second round of authentication 651 which may include a variety of security protocols and procedures to verify identify of the intended recipient as well as confirmation of the key 613. In the servers decision 652 that the key and intended recipient are authenticated then access to digital content in vault is allowed 625.

In some instances if intended recipient is authenticated then key 613 is utilized by the server to allow 620 intended recipient (with only one round of authentication) access to digital content in vault is allowed 625. In either instance the originator had previously been provide the optional choices to set private functions to manage content post access. In some instances that private function may be to destroy some or all content (as specified) upon one or more viewing, access or a download 627. The system may be restricted to allow only viewing or download. In some instances the settings may be to destroy digital content access records after a viewing/download 629. In some instances the settings may be to destroy records of one or more of intended recipient and that content was accessed or when 630.

FIG. 7B illustrates some aspects of a workflow for an originator using a secure vault and an intended recipient being provided tools to access digital records. In some instance the intended recipient goes through multiple levels of security screening prior to authentication and being granted access. An originator via a computing device creates a secure vault account 602. An intended recipient, in this exemplary is if said intended recipient is otherwise authenticated.

Once a vault account is created (or during the set-up process) the originator is prompted, preferably through a GUI, to identify intended recipient(s) 603. The originator is also prompted to establish DDC (digital Delivery conditions) 604. Prompts may include suggestion regarding social, economic, health, legal and other events which can trigger a DDC. Prompts may also include dates, time or gaps of times that may trigger a DDC. In those instances wherein the originator has linked biometric devices either remote or implanted in user, the data from such devices may be triggers for a DDC, in other instances gps from an implanted tracking device or from a computing device or sensor not-implanted but associated with originator may be used.

The originator utilizing a computing device in signal communications with a server, preferably through a GUI identifies or selects a human or robotic gatekeeper 633.

Once a secure vault for originator has been established, the originator can create or send 606 digital data content for storage 608. A very simple example is a first responder storing an audio or video or audio/video message for a loved one or other person in the event that he/she is killed or incapacitated that day. A more complex example is an originator adding voice notes, movie files and specific emails, documents, passwords, scraped social or professional network user pages etc. as records to be given to the intended recipient(s).

Once the originator account is activated the servers utilizing rule and/or decision engines determine if DDC or DDCs are met 610.

If DDC is met (optionally) a gatekeeper determines at least one of if the DDC is met and is the intended recipient(s) correct 611.

If DDC is considered met by one of server and gatekeeper+server then if DDC is met the server is contacted to provide a digital key to gatekeeper for delivery to intended recipient(s). 635. The gatekeeper contacts server via computing device and server utilizing a process determines whether or not the key should be delivered 650. If it is not delivered the server optionally contacts the server and reports failure. Server may also lock out account until potential unverified intended recipient/error/fraud is evaluated.

If gatekeeper is authenticated then key 613 delivered to gatekeeper. Gatekeeper in turn delivers key to intended recipient 637. The intended recipient goes through a second round of authentication 651 which may include a variety of security protocols and procedures to verify identify of the intended recipient as well as confirmation of the key 613. In the servers decision 652 the key and intended recipient are authenticated then access to digital content in vault is allowed 625.

In either instance the originator had previously been provide the optional choices to set private functions to manage content post access. In some instances that private function may be to destroy some or all content (as specified) upon one or more viewing, access or a download. The system may be restricted to allow only viewing or download. In some instances the settings may be to destroy digital content access records after a viewing/download. In some instances the settings may be to destroy records of one or more of intended recipient and that content was accessed or when.

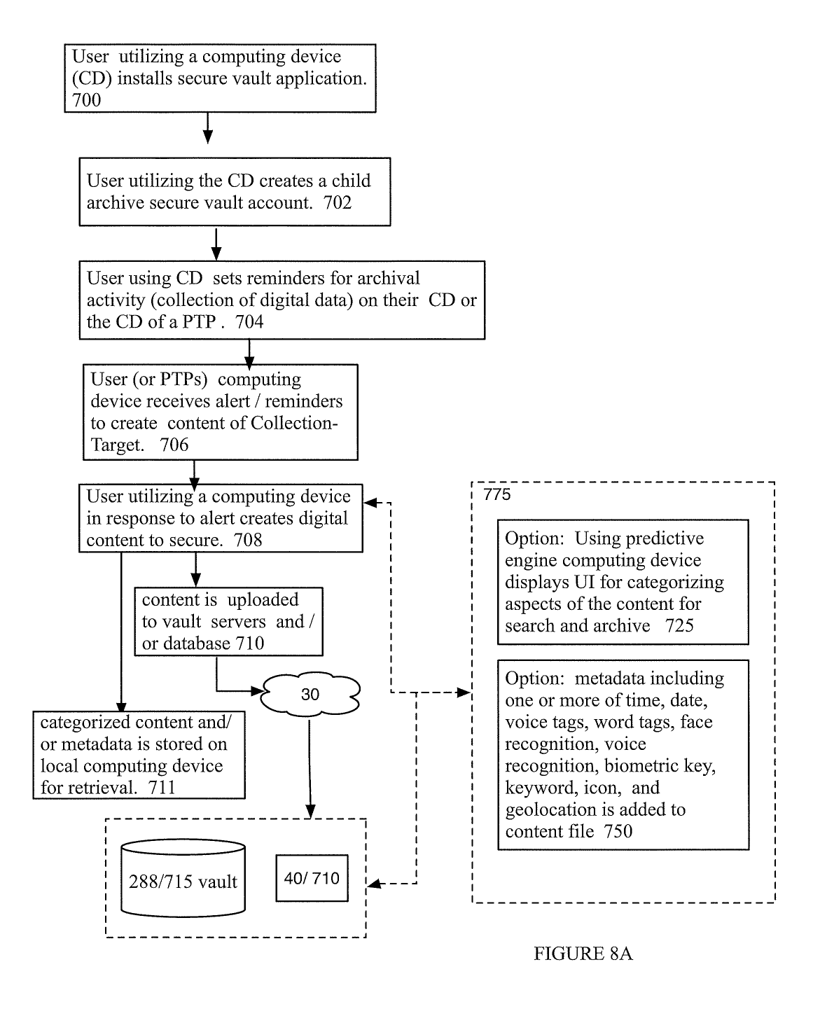

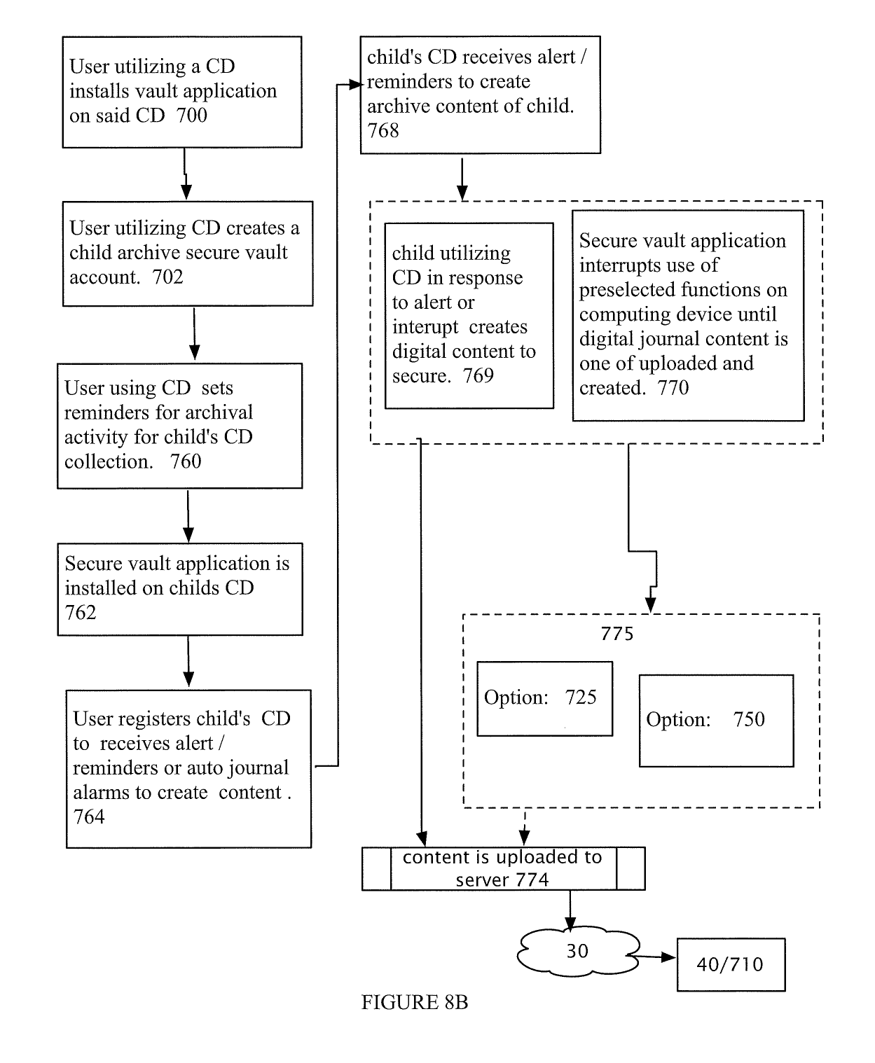

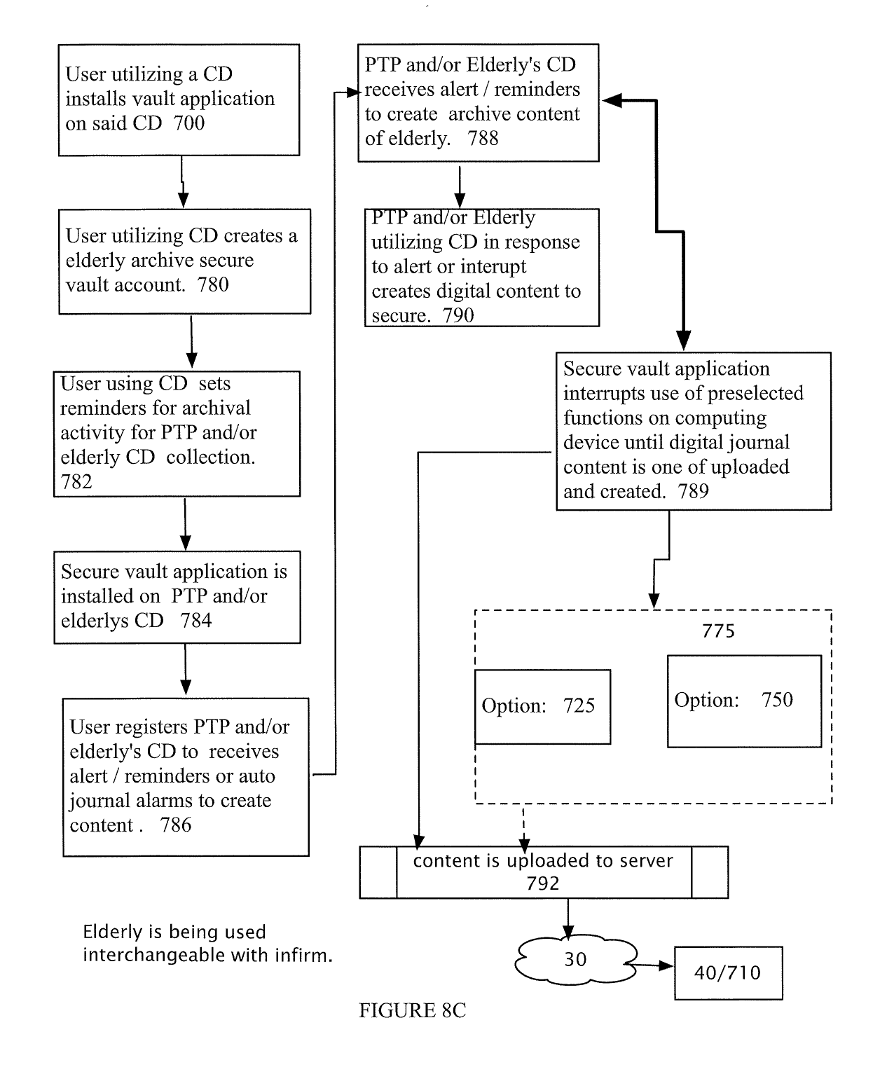

FIGS. 8A-8C illustrates aspects of the processes and workflow for a system to capture and transmit data in accordance with reminders and other Collection-Target processes or criteria. The disclosure is not limited to elderly, children and infirm people. These particularly vulnerable sub populations are merely examples.

In this non-limiting example FIG. 8A shows aspects of methods and systems to utilize a secure vault may include User utilizing a computing device (CD) installs secure vault application 700 whereby the user's computing device using signal communications can receive a push and/or pull collected data via a wired or wireless network or from a safe or secure vault server. The user utilizes a computing device to create a secure vault account to receive deposits from child 702. User using CD sets reminders for archival activity (collection of digital data) on their CD or the CD of a PTP 704. Archival activity includes capture of data from Collection-Target.

In some instances the PTP or User's computing device receives alert/reminders to create digital content of a child (or other Collection-Target) such as a pop or push notification on a smart phone wherein the user is reminded to capture the child 706. The notification could push to calendars or outlook. In some instances the reminder system includes and interrupts that requires the user to affirmatively chose not to capture the digital content which the user has set criteria on the system to reminder he/she to capture. In some instances the PTP in response to reminder utilizing a computing device creates/captures digital content 708. In some instances the User or PTP will have right to by-pass the reminder and not collect data, in other instances the reminder may lock some or all smart phone functions except emergency call until a collection is obtained. For a PTP, the collection or by-pass may be reported to the server and a notice to the User or other designated person.

Captured content may be saved on a remote archive by upload to vault servers 40/710, through a network 30 and then stored in a database 288/715 vault. Alternatively collected content is directed to a filtering rule and/or decision engine 775 which may include using predictive engine for categorizing aspects of the content for search and archive 725, and said predictive engine may have a user interface “UI”. The filtering may include processing or adding metadata such as one or more of time, date, voice tags, word tags, chemical, biologic, DNA, RNA, pheromone, recognition, voice recognition, biometric key, keyword, icon, and geolocation is to the digital content file 750. The categorization may happen all or in part at one or both of the User's CD (computing device) which may include a smartphone, and server and can be locally archived for retrieval 711.

In another non-limiting example FIG. 8B shows aspects of methods and systems to utilize a secure vault may include User utilizing a computing device (CD) installs secure vault application 700 whereby the user's computing device using signal communications can push and pull via a wired or wireless network from a safe or secure vault server. The user utilizes a computing device to create a secure vault account to receive deposits from child 702.

The user using a CD sets reminders for archival activity for child's CD for data collection 760. A vault application is installed on child's CD 762. User registers child's CD to receives alert/reminders or auto journal alarms to create content 764.

Child's CD receives alert/reminders to create data for archive content of child 768. Next, one of two options are available. Option one is the collection, and option two is an interrupt.

Collection option is when the child utilizing CD in response to alert or interrupt creates digital content to secure 769. Content may be free form, it may be in response to questions or images, it may be in response to a FACETIME™ or other video chat, it may be in response to an audio or video file being shown to child on a computing device such as a smart television. In some instances the Collection Machine or the computing device is a HAS. A drones and/or robot may in some instances be a part of a HAS.

Collected content can be secured (saved) on the computing device or uploaded 774 to a server 40/710 or computing device 20 via a network 30. Collected content on a local computing device is directed to a filtering rule and/or decision engine 775 which may include using predictive engine for categorizing aspects of the content for search and archive 725. The filtering may include processing metadata such as one or more of time, date, voice tags, word tags, face recognition, voice recognition, biometric key, keyword, icon, and geolocation is to the digital content file 750. The categorization may happen all or in part at one or both of the smartphone and server and can be locally archived and archived remotely.

Interrupt option is when the secure vault application interrupts use of preselected functions on computing device until digital journal content is one of uploaded and created 770. Collected content can be uploaded 774 to a server 40/710 via a network 30. Alternatively collected content is directed to a filtering rule and/or decision engine 775 which may include using predictive engine for categorizing aspects of the content for search and archive 725. The filtering may include processing metadata such as one or more of time, date, voice tags, word tags, face recognition, voice recognition, biometric key, keyword, icon, and geolocation is to the digital content file 750. The categorization may happen all or in part at one or both of the smartphone and server and can be locally archived and archived remotely.

In some instances the data being processed may trigger an alarm condition to contact the Collection-Target and/or to contact a designated person, parent or guardian or authorities. Alarms may be rules that decision that a threshold value indicating a need to communicate with the Collection-Target, that the Collection-Target needs help or that a pre-determined dangerous situation has been met. An unauthorized person in proximity to a Collection-Target or in proximity to a designated location may qualify as a dangerous situation.

In another non-limiting example FIG. 8C shows aspects of methods and systems to utilize a secure vault may include User utilizing a computing device (CD) installs secure vault application 700 whereby the user's computing device using signal communications can push 850 and/or pull 860 via a wired or wireless network from a server and/or database in signal communication with said database. The user utilizes a computing device to create a secure vault account to receive data content deposits from or about, for example, the elderly 780.

User using a CD sets reminders for archival activity for PTP or elderly's CD for data collection 782. Secure vault application is installed on PTP or elderly's CD 784. User registers PTP and/or elderly's CD to receives alert/reminders or auto journal is to create content 786. PTP or elderly's CD receives alert/reminders to create data for archive content 788. Next, one of two options are available. Option one is the collection, and option two is an interrupt.

Collection option is when the elderly or PTP utilizing CD in response to alert or interrupt creates digital content to secure 790. Collected content can be uploaded 792 to a server 40/710 via a network 30. Alternatively collected content is directed to a filtering rule and/or decision engine 775 which may include using predictive engine for categorizing aspects of the content for search and archive 725. The filtering may include processing metadata such as one or more of time, date, voice tags, word tags, face recognition, voice recognition, biometric key, keyword, icon, and geolocation is to the digital content file 750. The categorization may happen all or in part at one or both of the smartphone and server.

Interrupt option is when the secure vault application interrupts use of preselected functions on computing device until digital journal content is one of uploaded and created 789. Collected content can be uploaded 792 to a server 40/710 via a network 30. Alternatively collected content is directed to a filtering rule and/or decision engine 775 which may include using predictive engine for categorizing aspects of the content for search and archive 725. The filtering may include criteria and metadata such as one or more of time, date, voice tags, word tags, face recognition, voice recognition, biometric key, keyword, icon, and geolocation is to the digital content file 750. The categorization may happen all or in part at one or both of the smartphone and server.

In the above instances those of ordinary skill in the art will recognize that in many cases a POO or other Collection-Target may be substituted for the child without departing form the scope the disclosure.

In some instances the data being processed may trigger an alarm 102 or alarm condition to the Collection-Target and/or will contact via a computing device or server associates with a guardian or authorities 103. Alarms may be rules that decision that a threshold value indicating a Collection-Target needs help or may be in a dangerous situation has been met.

FIG. 9 illustrates aspects of systems for preparing captured content for archive, use, storage, retrieval, review and delivery of a content reel. A content reel refers to collection of capture data which, via a computing device, has been automatically parsed into a predetermined grouping, such as data capture at 9:05 am on Dec. 24, 2017. A reel is a term used to identify a virtual film reel of content which may be still image, video, audio, olfactory, health data, documents and the like.

A CD such as at least one of a server and smartphone constructs (processes) 820 a review reel, which may include augmenting a previous reel of data content. The processing takes into account criteria, or presets or selections. Construct as used here means to identify database records and create a sequential map of which can be provided to a user or reviewer or archive owner in a coherent organized fashion based on criteria. The same collection of digital media and records can be used to construct a multitude of reels based on user choices. The delivery of the content collected may be local on the smartphone and/or pushed to user or pulled by the smartphone from a server. That delivery is to a specific computing/viewing device. Once delivered the permitted recipient computing device may be used to add content, explanation, data stream (such a narrative) and keywords or connections to other content to the content. User or users are person or systems that have authorized access to the content of the reel.

In this method and system a user 10/11 interacts with a computing device (CD) having an application installed thereon or with a website via a user interface through a network 30 via signal communications to a server 901. computing device or server authenticates 902 the user. If authenticated the user may then interact with a content shaping module (CSM) 903. A non-limiting example is a CSM illustrated with only three of a universe of options. Those of ordinary skill in the art will recognize that having additional options is within the scope of this disclosure. Option A the user selects a preset of criteria for constructing a reel or the computing device generates a preset reel based on preset. Option B the user defines the criteria for constructing a reel. Criteria may include defining the reel by one or more of collection device(s), geographic location(s), time, date subject(s) via biometric, facial, voice or the like. Example: User may select all digital media with Bobby but none with Amy. The user may select cat climbing but not cat sleeping. The user may select Amy's birthday age 8 which would be connected to a date and/or event as well as subject. The user may select Bobby's response to question cues over the dates of Apr. 1, 2014-Apr. 7, 2104. Deep learning and other machine systems able to discern content in images and audio may be applied to sort through the collected content based on user rules and requests.

Option C at least one of a smartphone and server suggests criteria based on an analysis of capture digital data and its meta data such as time, geolocation, identified persons, Signiant dates (i.e. birthday, anniversary, holidays) a heuristic or predictive engine may be used. User may be provided suggestion from the CD for the content of a reel. In some instances the predictive engine may use the Predictive Analytics Module “PAM” 910 to develop suggestions based on one or more alternatives. In some instances the suggestions may be based on scraping from other family vaults to trend spot. Trend spotting may include repetitive uses of words, geolocation, objects, questions asked by users to Collection-Targets. The servers utilize heuristic engines(s) evaluate/analyze queries to a child from a population of parent/collectors or trend professional (i.e. teachers, doctors and pundits) and identify or predict trends for queries. Trends may be made available to other parent or collectors whereby such other parent/collectors may follow one or more trends in their inquiries to their child. For example what is celebrity “A” asking her child? What is my sister asker her child? What does Dr. X believe children should be queried with? In other instances the trends identified or predicted may be used by the server to amend of augment questing or inquiry to a child subject. A simple example in a demographic (age under 12) may be identifying a trend based on a food, media character, movie character, a song, a toy or a food. That trend can be used to predict that a child of X age and Y sex is more likely to respond to such a query. Another predictive query may be formulated by having the servers identify repeat words or images in digital media collected around a child. If a child is talking about a toy, icon, subject/item, for example BUZZ LIGHTYEAR™ or always playing with MEGATRON™, drawing a BARBIE™ and the like once the machine learning identifies the item and frequency of talking about, drawing, playing with or watching the object the system may place inquires via verbal, auditory, written or image in cue for use in collecting digital media. For example, ask Emily to draw a pony. Or ask Albert what does MEGATRON™ eat. In these ways a child's imagination can be shared via the collection and/or in trends may be sent to parent/collector for possible inclusion in future questing. In some instance with deep learning machines may ask the questions based on dynamic trending automatically without parent/collector approval.

CD suggestions can be based on the types of user presets of other users. Ten thousand other users may show a trend towards certain presets or identifiers. By having the servers 40 as part of a private network, although content collected s intended to be private archives, the servers can track choices in constructing reels and offer those choice and trends to other users without sharing content. The server may also filter content and make suggestions on quantity of subject matter content.

All of the above predictive inquires for collection may also be applied to Elderly. Trends in communicating with elderly or interfacing on subjects their demographic may be more likely to respond to is equally applicable. Subjects may include topics such as health concerns, isolation, cognitive functions.

In other instances suggestion may derive from a processing engine's analysis of a user's prior data deposit. In some instances suggestion may be based on the subject matter, age, location, date or user. In some instances suggestions may be based on data analysis of linked family accounts.

A function of the CSM module is to process 915 the collection of data and one or more of store the data compiled into a reel 920 stored local or uploaded for remote storage and delivery of the compilation 925 to other computing devices.

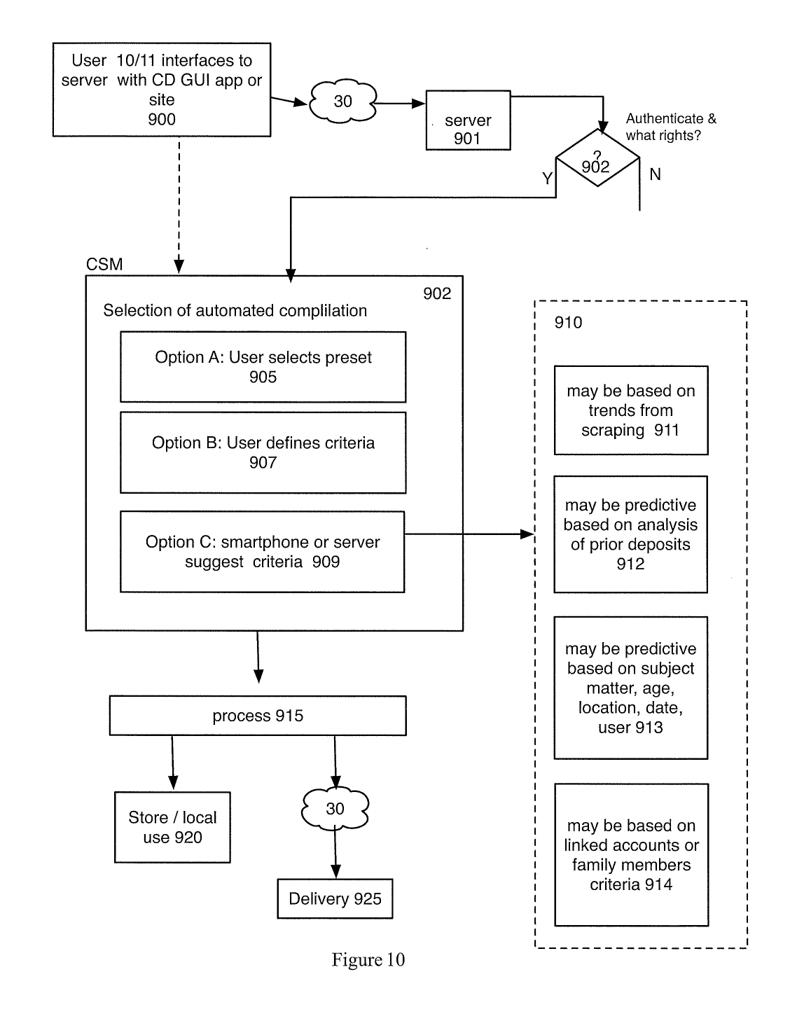

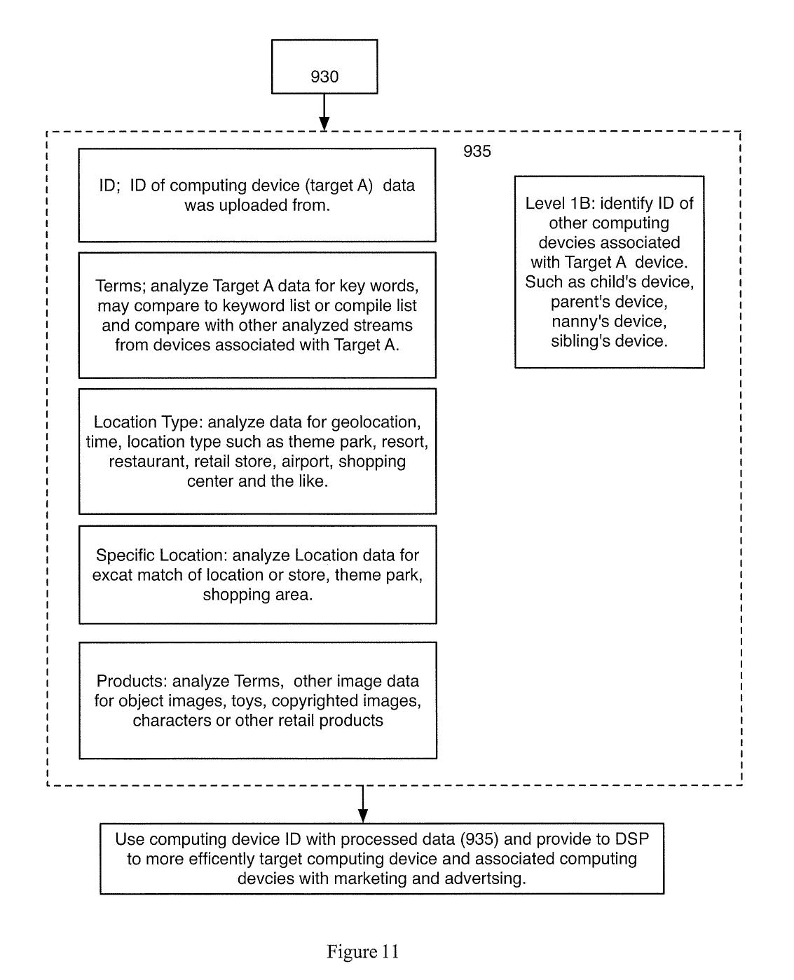

FIGS. 10 and 11 illustrate a system in which server(s) which analyzes the data deposits for purposes of marketing and advertising. Use of the collected data is via a digital sales system “DSS” which includes one or both of a DMP and DSP with a filtered a collection of information from one or more of family archives for one or more of trends, demographic information, geolocation, activity, items, objects consumer information, religious information, and social information for marketing. In some instances the server has in its database purchasing history, and browsing history for the vault depositor and/or the CD/machine ID of that associated with the deposit.

Deposits/captures 800 are sent via signal communication 810 to server 40 through a network 30 to be archived in private family vaults for users of the system. This is a private archive. The server 40 processes 825 the collected content deposit scrapping data and metadata. The server than, through a network 30 at least one of pushes 850 the processed collected content to parent 10 or collector 11, the parent 10 or collector 11 pulls 860 the processed collected content from the server (30) and the server (30) sends the processed information (collected content) to marketing and advertising server(s) 930 which may store the data in a database 932 and process 935 the data and meta data.

The collected data may include geolocation of the CD, the CDs machine ID, user of CD demographic data such as age and sex. In some instance browsing history may also be correlated to the Users CD machine ID. The collection may also correlate geolocation change with machine ID for CD. For example if smartphone 123 has gone from Atlanta to Orlando and making deposits while at Disneyworld that suggests a marketing or advertising opportunity which is different than if smartphone XYZ has left Flagstaff and is in Sedona. Alternatively it may be object data that is scraped. If deposits show LEGO™ being built over and over that may be meaningful. If audio recordings repeat a word that can be correlated a sellable thing (service or product) that may be meaningful.

Processing of the collected/deposited digital data may be at the archive server 40, the marketing advertising server 930 and/or the smartphone/computing device. Processing may include other records, from other sources which contain purchasing history, browsing history of user and/or geolocation of user's CD.

Once processed data, which may include CD ID correlated to data and meta data on services and products that may resonate with recipient are provided to the DSP.

A target recipient 945 who may also be a user is then the subject to targeted advertising and marketing 950.

It will be understood that various aspects or details of the invention may be changed without departing from the scope of the invention. It is not exhaustive and does not limit the claimed inventions to the precise form disclosed. Furthermore, the foregoing description is for the purpose of illustration only, and not for the purpose of limitation. Modifications and variations are possible in light of the above description or may be acquired from practicing the invention. The claims and their equivalents define the scope of the invention.

What is claimed is:

1. A digital and real world game, the method of the game comprising:
a computing device associated with an application on a collection target's computing device is used to play a game;
the game player sets at least one real world goal to be achieved via the app;
one or more autonomous or semi-autonomous Collection Machines in signal communication with a network collect activity data from or about the game player;
a sensor (26) associated with the Collection Machine triggers the data collection when the game player is at a predetermined distance from the collection machine;
the Collection Machine is in signal communication with a network;
collected content data is both stored in the Collection Machine memory and processed (107) to determine if a threshold level associated with the set goal is achieved; and,
if goal is achieved the data may be transmitted via the network to the host for the application and the application at least one of unlocks game features and adds score points to the collection targets game.

2. The method of claim 1 wherein a sensor (26) associated with the Collection Machine triggers the data collection.

3. The method of claim 2, wherein the Collection Machine utilizes one of image, voice, sound, movement, tracking device and heat as a criteria to initiate capture of data.

4. The method of claim 2, the method further comprising processing (915) the collected data according to at least one criteria.

5. The method of claim 1 wherein the collection targets activity is weighted by the server according to criteria to determine if the threshold is met.

6. A method of robotically preparing an entertainment graphic presentation, the method comprising: categorizing captured digital video or still photo content; using a filtering engine to at least one of categorize and filter the content; and, a reel of filtered and/or categorized content is generated.

7. The method of claim 6 wherein the categorizing and filtering include processing metadata such as one or more of time, date, voice tags, word tags, voice recognition, face recognition, biometric key, keyword, icon, and geolocation.

8. The method of claim 6 wherein one of the categorization and filtering takes place on the smartphone.

9. The method of claim 6 wherein one of the categorization and filtering takes place on a remote server.

10. The method of claim 6 wherein one of the categorization and filtering takes place on a local computing device different than a smart phone such as a home automated servant (86).

11. A method of autonomous warning of risk, the method comprising: digitally capturing content comprising; at least one of image, audio, biometrics, and near field or rfid identification information; categorizing captured content; using a filtering engine to at least one of categorize and filter the content; determine is a safety risk threshold is met and at least one of alerting a user and authorities by way of a network of said risk.
